(19) United States
(12) Patent Application Publication
(10) Pub. No.: US 2006/0232988 A1
(43) Pub. Date: Oct. 19, 2006

(54) Emitting light device for bicycles

(76) Inventors: Tseng-Fan Wang, Hsin-Tein (TW); Tseng-Huang Wang, Hsin-Tein (TW)

Correspondence Address: Wang, Tseng-Fan. Wang, Tseng-Huang, P.O. Box 166-13, Taipei, 115, TW

(21) Appl. No.: 11/108,547

(22) Filed: Apr. 19, 2005

(51) Int. Cl. F21V 33/00

(52) U.S. Cl. 362/475; 362/473; 362/192

(57) ABSTRACT

An emitting light device of the present invention is realized on the bicycle to generate and conserve electric power, to light the emitting light device. In practice a driven wheel combined with rotating portion (i.e. rear wheel) of the bicycle to form a center-pivot type of axis-joint rotating structure. A bicycle dynamo includes 1. an actuated wheel and a dynamo with a set of differential gears between them, 2. a PCB, and 3. a battery accumulator. A transmission belt is rotated around the driven and actuated wheels; an emitting light base has conducting cords connected to PCB of the dynamo. As the driven wheel rotates, the actuated wheel is driven to rotate by the transmission belt. The speed ratio of transmission is changed by a set of differential gears to run the dynamo generate DC electricity and conserve electricity for battery. DC electricity can be applied to light LED.

### FIELD OF THE INVENTION

The present invention is related to an emitting light device operated by a bicycle, particularly to a bicycle dynamo generates sufficient DC electricity to power an emitting base (i.e. handle bar stem head-lamp) emitting light by running on it's wheel, while the user rides bicycle.

### BACKGROUND OF THE INVENTION

Generally speaking, warning signal head lamps or emitting light devices applied to bicycles can be categorized as following:
1. Passive warning signal device: consists of reflective clothing panel and reflective film sticker, the key component of them are high reflective glass bead, adverse reflecting incident lights cause very strong back reflective effects to glow a spotlight-like eye-catching warning signal intermittently.
2. Active warning signal device: includes bulb, LED, luminescent panel and luminescent plate, they can be classified as self-activated light sources, one of the key components of them is luminescent pigments coating, emitting light by absorption of various visible lights and can be used repeatedly, it can be used for emergent lighting, indication marks.

Aforesaid passive or active warning signal devices can be applied to riding bicycles safely at night. At the sight of bicycles riding with shinning light sources, car drivers, motorcycle riders, and bus drivers on their way pay more attention to keep distance from riding bicycles. Thus the drivers and riders can avoid traffic accidents from ignoring the bike riding come near to them.

The users have to evaluate the effects of warning signal devices. Though passive warning signal device emits light without consuming DC power, but it needs an incident light to cause back reflective effects, such as a coming near car with headlamp shinning behind the back of the bike-rider, a street lamp or moonlight actuated as incident light source provides ideal performance. If the point light sources and ambient light are insufficient to provide an incident light, the reflection components will be inactivated. The passive warning signal will grow dim due to the diffuse lights are reduced to an invisible extent that naked eyes hardly catch sight of them. For increasing the effects of warning signal, lit up by active warning signal device or self-activated light source will be an ideal choice for eye catching display, particularly necessitates luminous elements to distinguish the warning signal at night from ambient light.

However, providing active warning or self-activated light source includes light bulb, LED and luminescent panel all need to consume the D.C. electricity. It needs to replace battery frequently. When riding bicycles on the way, the power of battery may be consumed up or the DC electricity is not sufficient to glow the handle bar stem head lamp, the active warning signal will grow dim gradually. Moreover, in practice a luminescent panel absorbs light from a fluorescent tube at night or being irradiated by the sun during day before applied it to glow through the darkness. The luminescent panel keeps glowing intermittently. After being exposed through irradiation to absorb light, they can be expected to glow again and again. Otherwise, the light emission of luminescent panel will grow dim until exposure in irradiation once more. Thus the luminescent panel is not preferrable for adorning with warning signals.

### SUMMARY OF THE INVENTION

Accordingly, in practice the warning signal of riding bicycle, illumination or related emitting light devices will grow dim due to either the ambient light source or electricity power is insufficient to supply. How to power an emitting light device without concerning about the insufficient supply of DC electricity is the primary object of the present invention.

Point against the aforesaid drawbacks, the present invention emitting light devices for bicycles as the claim 1 claimed comprising: A driven wheel is combined with a rotating portion (i.e. rear wheel) of the bicycle to form a center-pivot type of axis-joint rotating structure of the bicycle body; a bicycle dynamo 2 secured to the bicycle frame includes an actuated wheel, a dynamo, a set of transmission gears disposed between the actuated wheel and the dynamo, a PCB, and a battery accumulator; a belt 3 fits around the driven wheel 1 and the actuated wheel, the belt 3 is designed as a transmission medium between the driven wheel and the actuated wheel; and an emitting light base 4 disposed at a certain mountable position on the frame, at least an LED disposed in the emitting light base 4 as a light source, the LED connect to the PCB of bicycle dynamo by conducting cords; as the driven-wheel begins to start rotating the actuated wheel of the bicycle dynamo by running the belt 3 round; then changes speed ratio by a set of transmission gears to run the bicycle dynamo against the rim of tire to rotate and generate DC electricity, and conserves electricity for battery accumulator; the conserved electricity of the battery accumulator flows through the PCB and conducting cords so as to transfer electricity to the emitting light base 4, finally illuminates LED.

Emitting light devices for bicycles as the claim 2 claimed, which is dependent on claim 1. In that, a shift switch added to PCB to close or open the power source for electrifying the emitting light base.

Emitting light devices for bicycles as the claim 3 claimed, which is dependent on claim 2. In that, a vibration switch is substitute for the shift switch.

Emitting light devices for bicycles as the claim 4 claimed, which is dependent on claim 1. In that, two chain wheels can be substitute for the driven wheel and actuated wheel, the chain is designed as a transmission medium between two chain wheels.

Emitting light devices for bicycles as the claim 5 claimed, which is dependent on claim 1. In that, a capacitor can be substitute for a battery accumulator.

The merits of the present invention can be achieved as following:

As claim 1 claimed, in practice LED installed inside the emitting light device 4 is characteristic of eye-catching, low power consumption and low thermo-optical effects. LED are more durable and shock proof than the conventional tungsten filament burnt in a light bulb. The portable power source of the battery accumulator is achieved through the following three stages. First of all, the applied DC power is generated by a bicycle dynamo, and then conserves electricity for battery accumulator, finally; the electricity is applied to light LED. Thus regulates power supply and conserves electricity for battery accumulator. The present invention will not encounter the problems such as power deficiency, change battery, and recycling of battery.

As claim 2 claimed, in practice a shift switch is added to the PCB, control the power of emitting light base to light LED or not.

As claim 3 claimed, in practice a chain, differential gears and chain wheels are combined to form a transmission mechanism, which can prevent the power from running off and let the power transferred more directly.

As claim 4 claimed, in practice a capacitor can be substitute for a battery accumulator. It can be used for a short time as a cost-effective electricity conserved to light the LED rather than a battery accumulator.

### BRIEF DESCRIPTION OF THE DRAWINGS

FIG. 1: a schematic view of the structure of the emitting light device of the present invention;

FIG. 1A: a schematic view of the structure of the dynamo of the present invention;

FIG. 2: a schematic view of center-pivot type of axis-joint for combination of emitting light device and rear wheel; and

FIG. 3: a schematic view of the mounted portions of emitting light devices of the present invention.

### DETAILED DESCRIPTION OF THE INVENTION

The description is described in details according to the appended drawings hereinafter.

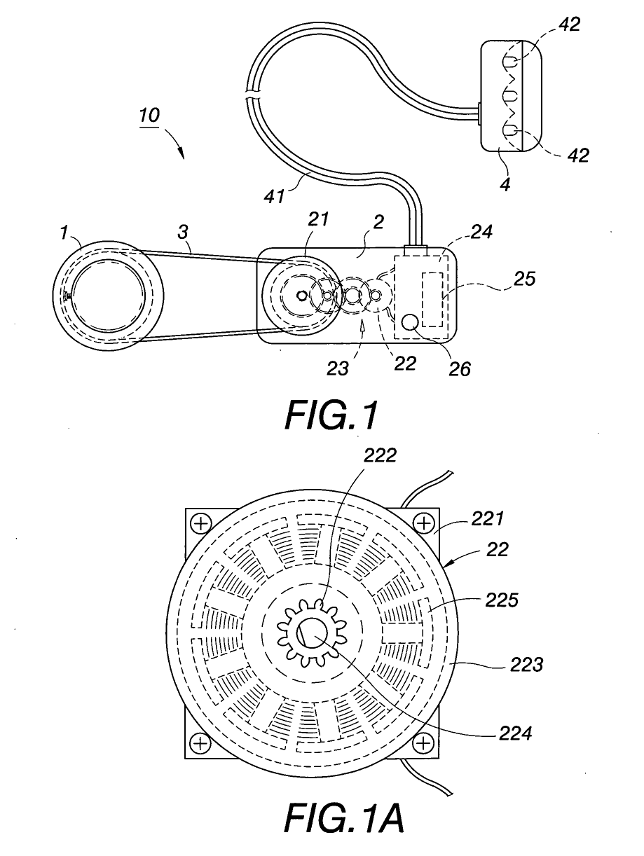

Referring to FIG. 1, a schematic view of the structure of an emitting light device of the present invention is shown. In that, an emitting light device 10 includes a driven wheel 1, a bicycle dynamo 2, a belt 3, and an emitting light base 4. Said bicycle dynamo 2 having an actuated wheel 21 disposed in itself, a dynamo 22, a set of differential gears 23 disposed between the actuated wheel and dynamo, a battery accumulator 25 (or a capacitor for a temporarily rechargeable electrification). Said belt 3 drives the driven wheel 1 and the actuated wheel 21, the belt 3 is designed as a transmission medium between them. Said emitting light base 4 has conducting cords 41 to connect to the PCB 24 of the bicycle dynamo 2. At least an LED 42 is disposed in the emitting light base 4 as the light source.

Referring to FIG. 1A, a schematic view of the structure of dynamo 22 is shown. In that, a pinion 222 is disposed on the back face of the laminate 221, and a magnetic hub 223 fits over the front face of the laminate 221. The pinion 222 is combined and aligned parallel with the magnetic hub 223 by a rotating shaft 224 passed through a pivot center of them. A coil 225 is disposed inside the magnetic hub 223 of the front face of the laminate 221. Said pinion 222 is driven to rotate with the magnetic hub 223 synchronously. And magnetic blocs are attached to the inner wall of the magnetic hub 223. As the magnetic hub is rotated with said pinion at the same time, a current will be induced to flow along the coil 225 due to the magnetism generated between said magnetic blocs and coil. According to the Faraday Law and Lenz Law, as the magnetic hub is driven to rotate; the magnetic flux of coil 225 is changed. And an induced electromotive force begins to form an induced current to flow around. A diode D1 (not shown) connected to the protection circuit is applied to control the induced current flow in a designated direction, which hinders the current from flow toward the cathode of the battery, and allows the induced current flow toward the anode of the battery, thus start a rechargeable process. Conversely, while the magnetic hub 223 rotates in the reverse direction, a reverse induced current flow around the coil 225, and a magnetic field is generated to resist the reverse induced current. Because the reverse induced current will be hindered by another diode D2 (not shown). So the reverse induced current will not flow toward the cathode of the battery, it will flow toward the anode of the battery to start another rechargeable process. The magnetism causes induced current is known to the prior arts, so only discusses about the simple steps as mentioned above.

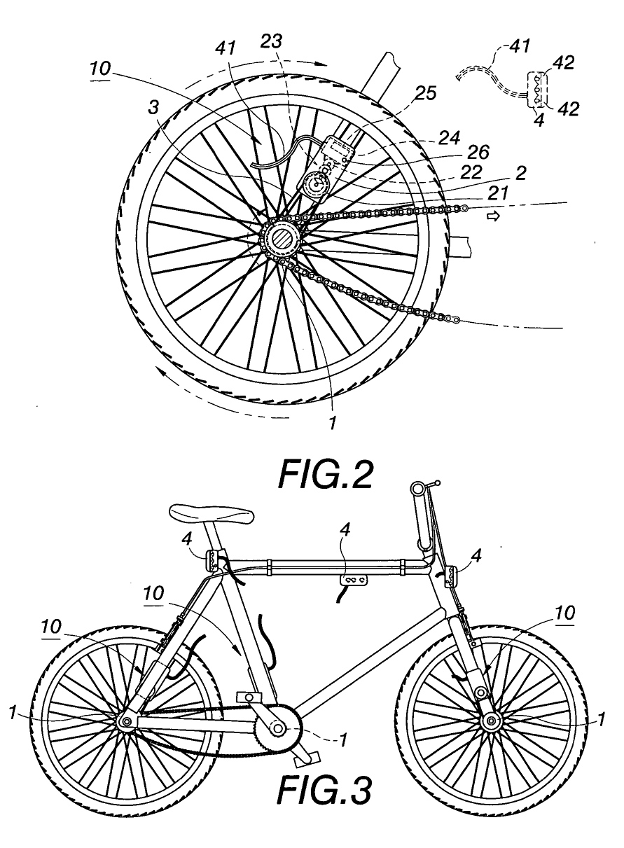

Referring to FIG. 2, a schematic view of the emitting light device of the present invention is shown. In that, a driven wheel 1 is disposed at a pivot center of the bicycle frame, for example, axles of the rear wheel of the bicycle. A bicycle dynamo 2 disposed on the rim of the rear wheel, but the emitting light base 4 can be mounted on any mountable portion of the bicycle. Said driven wheel 1 rotates with the rear wheel (i.e. rear sprocket) synchronously. After rotating the rear wheel, the actuated wheel 21 disposed in the bicycle dynamo 2 will be driven to rotate simultaneously by the link of transmission belt 3. The link of belt 3 is designed as a transmission medium between the bicycle dynamo and the rear wheel. A set of differential gears is applied to change the speed ratio of transmission so as to increase the speed. A magnetic hub 223 disposed in the bicycle dynamo is high-speed driven to generate DC power, and the generated DC power is conserved for a battery accumulator 25. The DC power is transferred from the battery accumulator 25 to the emitting light base 4 through the PCB 24 and conducting cords 41, the transferred DC power is applied to light an LED 42 disposed in the emitting light base 4. And a preset shift switch 26 is added to the PCB 24 so as to determine whether the current flow or LED 42 emitting light in selected ways.

Moreover, aforesaid driven wheel 1, actuated wheel 21 can be replaced by chain wheel and gear, and the belt 3 can be replaced by chain. In other words, said chain is designed as a transmission medium between the chain wheel and gear. In practice a vibration switch (not shown, conventional art) can be substitute for said power shift switch 26. As a light bicycle travels with light luggage for quick movement, through the trigger of vibration switch, a circuit is closed to induce a current flows around to light the LED 42. Conversely, as the bicycle stays in static state, the vibration switch will not light the LED 42 without induction.

Referring to FIG. 3, a schematic view of the emitting light device of the present invention is shown. The driven-wheel 1 of the emitting light device 10 is mounted on any rotating portion of the bicycle, which is formed as a center pivot type of axis-joint for combining the driven-wheel to any rotating portion of the bicycle, such as front wheel, rear wheel or sprocket (i.e. chain wheel) linked with the pedal, all of them can be a dynamic power source of the driven wheel 1. To meet the demands of the users, the emitting light base 4 can be disposed on any portion of the bicycle, such as the two lateral sides, the front side, the rear side of the frame, a beam frame structure, or a saddle pad.

1-4. (canceled)

5. A threaded rod device of manufacturing a nylon zipper comprising two parallel threaded rods; each threaded rod having threads; one of the threaded rod having a plurality of tips arranged in recesses between each two threads, the tips are formed as a single straight bank on the recesses of the threads of the threaded rod and is in the middle section of the threaded rod.

6. A threaded rod device of manufacturing a nylon zipper as claimed in claim 1, wherein a top of each tip has a concave recess so that the concave portion is a cambered recess without any sharp region.

7. A threaded rod device of manufacturing a nylon zipper as claimed in claim 2, wherein the plurality of cambered tips are straightly arranged along the threads of the thread rod.

8. A threaded rod device of manufacturing a nylon zipper as claimed in claim 2, wherein the plurality of cambered tips are straightly arranged at a middle section of the threaded rod.

9. A threaded rod device of manufacturing a nylon zipper comprising steps of forming a concave portion and a corresponding convex portion after clamping the nylon gripper elements to have an elliptical shape wherein a plurality of tips formed on the recesses of middle section of one short threaded rod continuously press the nylon griper element in sequence as another long threaded rod guiding nylon wires to wind upward.
